(19) United States
(12) Patent Application Publication
(10) Pub. No.: US 2007/0137496 A1
(43) Pub. Date: Jun. 21, 2007

(54) Filling and/or change monitoring method in a cooking device and cooking device with filling and/or charge monitoring

(75) Inventors: Manfred Breunig, Schongau (DE); Bruno Maas, Kaufering (DE); Roland Hegmann, Langerringen (DE); Rudolf Konig, Weil/Ortsteil Geretshausen (DE); Ralph Macenka, Landsberg/Lech (DE); Klaus Altenburgen, Waldbronn (DE); Judith Imgram, Hanau (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: RATIONAL AG, Landsberg/Lech (DE)

(21) Appl. No.: 10/579,017

(22) PCT Filed: Nov. 5, 2004
(86) PCT No.: PCT/DE04/02449

§ 371 Date: Oct. 30, 2006

(30) Foreign Application Priority Data
Nov. 13, 2003 (DE) 103 53 193.9-16
Mar. 15, 2004 (DE) 2004 012 824.3

(51) Int. Cl. A47J 37/04

(52) U.S. Cl. 99/341

(57) ABSTRACT

A filling and/or charge-amount-monitoring method for a reservoir for storage of a fluid in a cooking device with an inner casing, including a cooking chamber with a fluid inlet and a fluid outlet, a ventilation device with a fan inside the inner casing, for the circulation of a part of the fluid in the inner casing and a control or regulation device, cooperating with the ventilation device and/or a filling and/or charge-amount-monitoring device, whereby a characteristic parameter for the ventilation device, changing on the basis of the force exerted by the fluid incident on the fan, is analyzed by the filling and/or charge-amount-monitoring device and may be rotation speed, power or current consumption of the ventilation device and a cooking device with a filling and/or charge-amount-monitoring.

### RELATED APPLICATIONS

This is the U.S. national phase of International Application No. PCT/DE2004/002449 having an international filing date of Nov. 5, 2004, the entire disclosure of which is hereby expressly incorporated herein by reference and claims priority to DE 103 53 193.9 filed Nov. 13, 2003 and DE 10 2004 012 824.3 filed Mar. 15, 2004.

### TECHNICAL FIELD

The present disclosure concerns a filling and/or charge-amount-monitoring method for at least one reservoir for at least occasional accommodation of at least one fluid in a cooking device with an inner casing, including a cooking chamber with at least one fluid inlet and at least one fluid outlet, a ventilation device, including at least one fan in the inner casing, at least one drive shaft for the fan and at least one motor for the drive shaft, for circulating at least a part of the fluid at least in the inner casing and a control or regulation device cooperating with the ventilation device and/or a filling- and/or charge-amount-monitoring device; and a cooking device with an inner casing, including a cooking chamber with at least one fluid inlet and at least one fluid outlet, a ventilation device, comprising at least one fan in the inner casing, at least one drive shaft for the fan and at least one motor for the drive shaft for the circulation of at least a part of at least one fluid at least in the inner casing, at least one reservoir for at least occasional accommodation of at least the fluid with at least one fluid inlet and at least one fluid outlet, a filling- and/or charge-amount-monitoring device for the reservoir and a control- or regulation device cooperating with the ventilation device and/or the filling- and/or charge-amount-monitoring device.

### BACKGROUND ART

Cooking devices that are well-known in the art include, for example, one such device disclosed in WO 02/068876 A1. From this publication, a method and a device are known for the cleaning of a cooking device with the introduction of fresh water, which can be filled particularly from the boiler of a steam generator, either by overfilling the boiler, branching of water, heated at least once or even boiled water, or by condensation of vapors, into a washing liquor reservoir, optionally at the same time with at least one cleaning agent. The washing liquor is then circulated for cleaning, namely from the washing liquor reservoir, which is preferably formed by a steam condenser especially provided in the form of a quenching chamber, to the suction side of a fan, through the cooking chamber and a cooking chamber outlet back into the washing liquor reservoir. In this way the circulation and composition of the washing liquor, including the duration, temperature, flow rate and similar can be controlled and/or regulated. In the cooking device known from WO 02/068876 A1 a filling level electrode is used in the boiler as the manifestation of a filling- and/or charge-amount-monitoring device.

Additionally, DE 197 30 610 C1 discloses a cleaning method for a cooking device using a cleaning fluid which is filled into an inner casing of the cooking device sealed toward the outside to such a filling height that the bottom of the inner casing is at least completely covered, that is, it serves as reservoir for the cleaning fluid. The cleaning fluid is then circulated with a circulation device in such a way that the inner surface of the inner casing is rinsed with the cleaning fluid at least partly. A filling level electrode is provided for detecting the filling height in the inner casing.

Filling level electrodes have the disadvantage that when they are used in cooking devices they are easily contaminated and thus liable to develop defects. In addition, such filling level electrodes also represent additional components for which extra structural space is needed and this results in costs.

As an alternative to filling level electrodes in cooking devices, liquid flow meters are also used, such as in the form of pulse counters and similar devices, see for example DE 199 12 444 C2. Fluid flow meters are also liable to develop problems, require structural space and are costly.

Dishwashing machines, which are in an entirely different technical area than cooking devices, are known, for example, from DT 25 55 052 A1, in which a control device is provided for a program-controlled introduction of water, where the intake of fresh water is controlled as a function of the motor current of a circulating pump.

For washing machines, which differ from cooking devices just as dishwashers do, it is known that the running of the program can be controlled as a function of the rotation speed of the washing drum, see, for example, DE 41 17 292 C2.

### SUMMARY OF THE DISCLOSURE

Therefore, a task of the present disclosure is to further develop the generic method as well as the cooking device in such a way that the disadvantages of the state of the art are overcome.

The task concerning the method is solved according to the disclosure by the fact that at least one characteristic parameter of the ventilation device, which changes based on the action of force of the amount of fluid incident on the fan, is evaluated by a filling- and/or charge-amount-monitoring device.

Hereby, it can be provided that for monitoring a filling and/or charge-amount, a rotation speed, a fluctuation of the rotation speed, a power consumption, a fluctuation of the power consumption, a current consumption and/or a fluctuation of the current consumption of the ventilation device is /are determined at least intermittently as characteristic parameter for monitoring the filling and/or charge amount.

According to one aspect of the disclosure, at least a part of the fluid at least in the inner casing is circulated by at least one pumping device, whereby the pumping device is preferably pulsed.

Hereby it can be provided that at a time point t₀ the pumping device is turned on, at a time point t₁ a reduction of the rotation speed of the fan is detected based on the amount of fluid incident on the fan, where preferably this reduction in rotation speed is then compensated by the motor at least partly by increasing power consumption, at a time point t₂ the pumping device is turned off, at a time point t₃ an increase of the rotation speed is detected, especially because of the said compensation by the motor, and the filling- and/or charge-amount and/or a change of these is/are determined from the time difference t₃-t₁.

Furthermore, it is proposed by an aspect of the disclosure that an upper limiting value of the rotation speed and/or a lower limiting value of the rotation speed is/are determined, preferably as a function of the pulsing of the pumping device, of the amount of fluid introduced into the inner casing, of the amount of fluid removed from the inner casing, of the dimension of the cooking device, of the accessories in the cooking device and/or of the loading of the inner casing with cooking product.

Hereby it can be provided that a time difference is determined from the time span between going below the lower limiting value and exceeding the upper limiting value, preferably as a function of the pulsing of the pumping device, for filling- and/or charge-amount-monitoring.

Furthermore, according to another aspect of the disclosure, it can be provided that, as a function of a detected filling- and/or charge-amount, at least one device for introducing fluid into the inner casing and/or at least one device for removing fluid from the inner casing is/are adjusted, preferably controlled or regulated.

Therefore, the task of the disclosure regarding the cooking device is solved by the fact that the filling- and/or charge-amount-monitoring device is cooperating with the ventilation device to determine at least one parameter characteristic for the amount of fluid incident on the fan.

Hereby it can be provided that the motor, preferably in the form of an electric commutated motor works in cooperation with the control- or regulation device.

Preferred cooking devices of the disclosure include at least one pumping device for circulating at least part of the fluid at least in the inner casing, preferably working in cooperation with the control- or regulation device for adjusting the pump output and/or the pulsing of the pumping device.

Another aspect of the disclosure includes the characteristic parameter be determinable by evaluation of the rotation speed, the fluctuation of the rotation speed, the power consumption, the fluctuation of the power consumption, the current consumption and/or the fluctuation of the current consumption.

According to another aspect of the disclosure, it is preferable when, in the determination of the characteristic parameter, the pulsing of the pumping device can be taken into consideration, preferably the time span between a first reduction of the rotation speed after turning on the pumping device and a first increase of the rotation speed after turning off the pumping device, especially during a pulse, can be evaluated.

Furthermore, another aspect discloses that the fluid comprises water in the liquid and/or vapor form and/or a washing liquor.

Yet another aspect discloses that the reservoir is provided in the inner casing, in a quenching chamber and/or in a boiler of a steam generator.

Hereby, it can be provided that the inner casing can be filled through a first fluid inlet, in cooperation with the quenching chamber, a second fluid inlet in cooperation with the boiler and/or a third fluid inlet in cooperation with a water line.

Still another aspect discloses that the quenching chamber can be filled through a fourth fluid inlet in cooperation with the inner casing, a fifth fluid inlet in cooperation with the boiler and/or a sixth fluid inlet in cooperation with a water line.

Furthermore, the disclosure provides that the boiler can be filled through a seventh fluid inlet in cooperation with the inner casing, an eighth fluid inlet in cooperation with the quenching chamber and/or a ninth fluid inlet in cooperation with a water line.

It can also be provided that the first fluid inlet is in cooperation with a first shut-off device and/or pumping device, the second fluid inlet is in cooperation with a second shut-off device and/or pumping device, the third fluid inlet is in cooperation with a third shut-off device and/or pumping device, the fourth fluid inlet is in cooperation with a fourth shut-off device and/or pumping device, and the fifth fluid inlet is in cooperation with a fifth shut-off device and/or pumping device, the sixth fluid inlet is in cooperation with a sixth shut-off device and/or pumping device, the seventh fluid inlet is in cooperation with a seventh shut-off device and/or pumping device, the eighth fluid inlet is in cooperation with an eighth shut-off device and/or pumping device and/or the ninth fluid inlet is in cooperation with a ninth shut-off device and/or pumping device.

According to another aspect of the disclosure, it is proposed that the inner casing can be emptied through a first fluid outlet in cooperation with the quenching chamber, a second fluid outlet in cooperation with the boiler and/or a third fluid outlet in cooperation with a water discharge.

Furthermore, it can be provided that the quenching chamber can be emptied through a fourth fluid outlet in cooperation with the inner casing, a fifth fluid outlet in cooperation with the boiler and/or a sixth fluid outlet in cooperation with a water discharge.

Embodiments according to the disclosure can be characterized by the fact that the boiler can be emptied through a seventh fluid outlet in cooperation with the inner casing, an eighth fluid outlet in cooperation with the quenching chamber and/or a ninth fluid outlet in cooperation with a water discharge.

It can be provided that the first fluid outlet is in cooperation with a tenth shut-off device and/or pumping device, that the second fluid outlet is in cooperation with an eleventh shut-off device and/or pumping device, that the third fluid outlet is in cooperation with a twelfth shut-off device and/or pumping device, that the fourth fluid outlet is in cooperation with a thirteenth shut-off device and/or pumping device, that the fifth fluid outlet is in cooperation with a fourteenth shut-off device and/or pumping device, that the sixth fluid outlet is in cooperation with a fifteenth shut-off device and/or pumping device, that the seventh fluid outlet is in cooperation with an sixteenth shut-off device and/or pumping device, that the eighth fluid outlet is in cooperation with a seventeenth shut-off device and/or pumping device, and/or that the ninth fluid outlet is in cooperation with an eighteenth shut-off device and/or pumping device.

It is suggested according to an aspect of the disclosure that the first, second, third, fourth, fifth, sixth, seventh, eighth, ninth, tenth, eleventh, twelfth, thirteenth, fourteenth, fifteenth, sixteenth, seventeenth and/or eighteenth shut-off device includes/include at least one valve.

Furthermore it can be provided that the first, second, third, fourth, fifth, sixth, seventh, eighth, ninth, tenth, eleventh, twelfth, thirteenth, fourteenth, fifteenth, sixteenth, seventeenth and/or eighteenth shut-off device and/or pumping device can be actuated through the control- or regulation device, especially always as a function of a comparison of the actual value of the characteristic parameter with at least one target value for the characteristic parameter.

Hereby, it can be provided that the pulse ratio of the first, second, third, fourth, fifth, sixth, seventh, eighth, ninth, tenth, eleventh, twelfth, thirteenth, fourteenth, fifteenth, sixteenth, seventeenth and/or eighteenth shut-off device and/or pumping device can be adjusted, especially controlled or regulated, through the control- or regulation device.

Finally, according to an aspect of the disclosure, it is proposed that the filling- and/or charge-amount-monitoring device includes the ventilation device and the control- and/or regulation device at least partly, whereby the filling- and/or charge-amount-monitoring device preferably also includes the first, second, third, fourth, fifth, sixth, seventh, eighth, ninth, tenth, eleventh, twelfth, thirteenth, fourteenth, fifteenth, sixteenth, seventeenth and/or eighteenth shut-off device and/or pumping device.

Thus, the disclosure includes means of the evaluation, for example, of the rotation speed fluctuations of a fan in a cooking device, that can concern amplitudes, frequencies, phases or time separations to one another, in the case in which a fan and optionally a pumping device is used in an inner casing of the cooking equipment to circulate, for example a washing liquor, which is pumped in a pulsating manner from a quenching chamber into the inner casing and from the inner casing flows back into the quenching chamber, so that sufficiently exact information can be obtained about the state of filling or about the amount of filling of the washing liquor recirculation circuit, based on the fact that the fan is slowed down by the washing liquor incident on it, so that a load change occurs, which is manifested, among other things, in rotation speed fluctuations. On the other hand, the current consumption or power consumption in the case of a load change due to the washing liquor incident on the fan can also be evaluated, according to an aspect of the disclosure, especially in the form of the evaluation of the deviations from a target value, whereby in case of small deviations, the circulating washing liquor amount is small and in case of large deviations the circulation washing liquor amount is large.

In one form, a time difference is used as a measure for filling- and/or charge-amounts and/or a change of these, which is determined from the time span between going below a lower limiting value and exceeding an upper limiting value of the rotation speed of the fan within a pump pulse. Namely, in the case of a predetermined pulsing of a pumping device, it is observed that at time t₁ after turning on the pumping device at a time point t₀, a reduction in the rotation speed occurs due to the braking effect of the fan by the incident washing liquor. Advantageously, this lowering is preferably compensated by an increasing power consumption by the motor, which is preferably an electrically commutated motor, which provides rapid adjustment to the applied load, in such a way that after a certain time span after turning off the pumping device at time t₂, namely at time t₃, an increase of the rotation speed can be observed. Thus the time difference t₃-t₁ represents a characteristic parameter of the fan in a cooking device according to an aspect of the disclosure, and this can be used for the evaluation of a filling- and/or charge-amount. Moreover, this time difference is independent of changeable components in the cooking device, such as in the form of different accessories or also in case of different loading of the cooking device.

Thus, it is taken into consideration for the first time that, especially during cleaning in a cooking device, the fluid circuit is decisive for satisfactory cleaning results, and that the filling, that is, the state of filling or the charge-amount of the fluid circuit with fluid, can be determined through the consequences of the impingement of fluid on the fan for the purpose of controlling the fluid circuit.

The data to be evaluated in a cooking device according to the disclosure for the purpose of monitoring of filling or a charge-amount, that is, for example, the fluctuations of the rotation speed, can naturally be further processed for the purpose of evaluation, especially they can be subjected to filtering. In addition, according to the disclosure, it is provided that a target value/actual value comparison be performed in a control- and/or regulation device, in order to control, as a function of the result of the said comparison, especially the introduction of fresh water, for example by opening a valve to a water line in the quenching chamber.

Further characteristics and advantages of the disclosure follow from the description of a practical example given below in reference to the drawing.

### BRIEF DESCRIPTION OF THE DRAWINGS

FIG. 1 is a schematic representation of a cooking device according to the principles of the present disclosure.

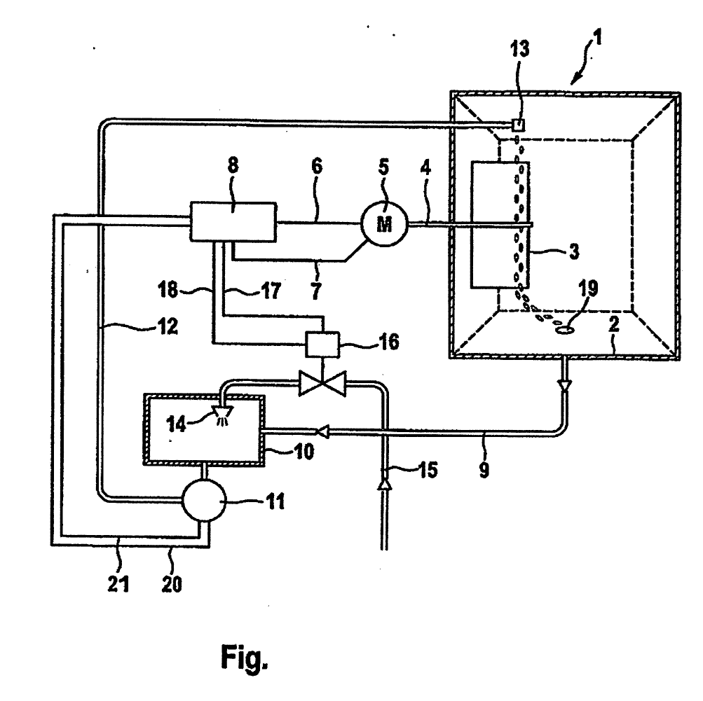

### DETAILED DESCRIPTION

As can be seen from the figure, a cooking device 1 includes an inner casing 2, in which a fan 3 is arranged. The fan 3 is connected to a motor 5 through a drive shaft 4. In turn, the motor 5 is connected through a control line 6 as well as through a measuring line 7 to a control device 8. In addition, the inner casing 2 is connected to a quenching chamber 10 via an outlet line 9, and the quenching chamber in turn is connected again to the inner casing 2 through an exit member 13, with a pump 11 and a washing liquor line 12 being connected in-between. Furthermore, the quenching chamber 10 can be filled through a quenching nozzle 14 with fresh water from a water line 15 when valve 16 is opened, whereby valve 16 in turn is connected through a control line 17 but also through a measuring line 18 to the control device 8. The fresh water is a component of a fluid 19 which, using pump 11, which is also connected to the control device 8 through a control line 20 and a measuring line 21, is circulated in cooking device 1, especially during a cleaning process. In the case of a cleaning process, the fluid is called washing liquor 19. Finally, through an outlet 24, washing liquor 19 can be discharged from the circulation circuit of cooking device 1, especially through quenching chamber 10 with a valve 21 being connected in-between. The water line 15 as well as the discharge 24 can be a component of a house water supply. Valve 21 is connected to control device 8 through measuring line 22 as well as through a control line 23.

The cooking device 1 which was just described can operate as follows for monitoring the filling and the charge of the quenching chamber 10 according to a practical example of the method:

With the beginning of a cleaning phase, the initially empty quenching chamber 10 is filled with fresh water through quenching nozzle 14. The fresh water introduced into quenching chamber 10 is immediately moved to exit member 13 via pump 11 in order to impinge from there onto fan 3. The pump 11 operates at an adjustable pulse ratio, such as, for example, 10 seconds on and 5 seconds off. The pulse ratio can be changed as desired via the control device 8.

The valve 16 is then closed through control device 8, but only when a comparison of a first target value for the load consumption of the fan 3 agrees with the actual value of the load consumption measured through measuring line 7, due to braking by the impinging washing liquor 19, which corresponds to a desired charge of the circuit of the washing liquor 19. Then the filling monitoring is completed. Subsequently there is a charge-amount-monitoring of the washing liquor 19 which circulates from the inner casing 2 into quenching chamber 10 and back to the inner casing, that is, of the fluid circuit, by evaluation of the variance of the rotation speed, that is, of the rotation speed fluctuations, or more accurately of the magnitude of the rotation speed fluctuations of the fan 3. The magnitude of the fluctuations permits one to draw conclusions about the recirculating efficiency in the cooking device. While a homogeneous rotation speed of fan 3 would indicate no or only slight influence of the fan 3 by washing liquor 19, an inhomogeneous rotation speed, which can be evaluated via the rotation speed fluctuations, is an indication of intact circulation. In the evaluation of rotation speed fluctuations, a target value of the rotation speed is considered as reference point and a filtration is performed. Furthermore, during evaluation through the control device 8, the pulse ratio of pump 11 is also taken into consideration, whereby it should be pointed out that without pulsing of pump 11, the motor 5 would adjust to a given load and thus the rotation speed of fan 3 would be regulated up to a target value, which would not permit the determination of the charge in the circuit.

Now, if the evaluation of the rotation speed fluctuations of fan 3 show that the charge-amount of washing liquor 19 necessary for cleaning is not present in the circuit of the cooking device 1, valve 16 is opened until the optimum charge is achieved.

Furthermore, in different cleaning steps a different charge-amount of washing liquor 19 may be necessary so that different target values exist with which a comparison is performed during the cleaning process.

In order to be able to perform a monitoring of the filling- and/or charge-amount in the inner casing 2 with, for example, washing liquor 19 independently of special accessories as well as cooking product (neither of them are shown) in another practical example, it is preferred to evaluate time differences. For example, if the charge-amount of washing liquor 19 is to be kept constant during a cleaning phase, then, for a given pulsing of pump 11, the following procedure can be followed, for example, several times:

At a time t₀ the pump 11 is turned on. As soon as a reduction of the rotation speed is observed, especially in the form of going below the first target value, time t₁ is determined. If then, due to increasing power consumption of motor 5, this reduction of the rotation speed is compensated, the time should be noted at which, after turning off pump 11 at time t₂, an increase in rotation speed especially in the form of exceeding a second target value is observed, then this time is to be noted as time t₃. Then the difference t₃-t₁ gives a measure of the charge-amount whereby a third target value or a target value range exists for a desired amount of charge. If the difference t₃-t₁ then goes below, for example, this third target value, that indicates that there is a lack of washing liquor 19. This lack of washing liquor 19 is possible, for example, as a result of the introduction of further fresh water by activating valve 16 of the quenching nozzle 14 through control device 8. However, if the difference t₃-t₁ is, for example, greater than the third target value, especially no increase of the rotation speed is observed after turning off pump 11, then, the valve 16 to quenching nozzle 14 can, for example, be activated by the control device 8. Namely, in the latter case it is to be assumed that, again, there is a lack of washing liquor 19, that is, the amount of washing liquor 19 has reduced slowly during the cleaning process in the time period from t₀ to t₃. Overfilling with washing liquor 19 is not to be assumed, especially because of the presence of an emergency overflow, which is not shown.

The characteristics of the disclosure provided in the above description, in the claims as well as in the drawing can be essential individually but also in any arbitrary combination for the realization of the cooking device in its various embodiments.

### Reference List

1 Cooking device
2 Inner casing
3 Fan
4 Drive shaft
5 Motor
6 Control line
7 Measuring line
8 Control device
9 Outlet line
10 Quenching chamber
11 Pump
12 Washing liquor line
13 Exit member
14 Quenching nozzle
15 Water line
16 Valve
17 Control line
18 Measuring line
19 Fluid
20 Control line
21 Valve
22 Control line
23 Measuring line
24 Discharge

1. A method for filling- and/or charge-amount-monitoring at least one reservoir, the reservoir for at least intermittent accommodation of at least one fluid in a cooking device with an inner casing, the inner casing including a cooking chamber with at least one fluid inlet and at least one fluid outlet, a ventilation device including at least one fan in the inner casing, at least one drive shaft for the fan and at least one motor for the drive shaft, the ventilation device for the circulation of at least a part of the fluid at least in the inner casing, and a control or regulation device cooperating with the ventilation device and/or a filling- and/or charge-amount-monitoring device, the method comprising: evaluating at least one change in a characteristic parameter of the ventilation device by the filling- and/or charge-amount-monitoring device, the change due to the action of force of an amount of fluid incident on the fan.

2. The method according to claim 1, wherein evaluating at least one change in a characteristic parameter includes at least intermittently determining at least one of a rotation speed, a rotation speed fluctuation, a power consumption, a power consumption fluctuation, a current consumption and a current consumption fluctuation of the ventilation device.

3. The method according to claim 1, further comprising:
circulating at least a part of the fluid at least in the inner casing through at least one pumping device.

4. The method according to claim 3, further comprising:
turning on the pumping device at a time point t₀, detecting a reduction of the rotation speed of the fan due to the amount of fluid incident on the fan at a time point t₁,
turning off the pumping device at a time point t₂, detecting an increase of the rotation speed by the motor at a time point t₃, and
determining the filling- and/or charge-amount and/or a change of these from the time difference t₃-t₁.

5. The method according to claim 2 further comprising:
determining at least one of an upper limiting value of the rotation speed and a lower limiting value of the rotation speed.

6. The method according to claim 5, further comprising:
determining a time difference from a time span between when the value goes below the lower limiting value and when the value goes above the upper limiting value.

7. The method according to claim 1, wherein evaluating at least one change in a characteristic parameter of the ventilation device includes adjusting at least one of a device for the introduction of fluid to the inner casing and a device for removing fluid from the inner casing.

8. A cooking device comprising:
an inner casing having a cooking chamber with at least one fluid inlet and at least one fluid outlet;
a ventilation device having at least one fan in the inner casing, at least one drive shaft for the fan, and at least one motor for the drive shaft, the ventilation device for the circulation of at least a part of at least one fluid at least in the inner casing;
at least one reservoir for the at least intermittent accommodation of at least the fluid with at least one fluid inlet and at least one fluid outlet;
a filling- and/or charge-amount-monitoring device for the reservoir; and
a control or regulation device cooperating with at least one of the ventilation device and the filling- and/or charge-amount-monitoring device, such that the filling- and/or charge-amount-monitoring device cooperates with the ventilation device for the determination of at least one parameter characteristic for the amount of fluid incident on the fan.

9. The cooking device according to claim 8, wherein the motor cooperates with the control- or regulation device.

10. The cooking device according to claim 8, further comprising:
at least one pumping device for circulating at least a part of the fluid at least in the inner casing.

11. The cooking device according to claim 8, wherein the characteristic parameter can be determined by evaluation of at least one of a rotation speed, a rotation speed fluctuation, a power consumption, a power consumption fluctuation, a current consumption and a current consumption fluctuation.

12. The cooking device according to claim 10 wherein in the determination of the characteristic parameter, a pulsing of the pumping device can be taken into consideration.

13. The cooking device according to claim 8, wherein the fluid includes at least one of water in the liquid form, water in the vapor form, and a washing liquor.

14. The cooking device according to claim 8, wherein the reservoir is provided in one of the inner casing, a quenching chamber and a boiler of a steam generator.

15. The cooking device according to claim 14, wherein the inner casing can be filled through at least one of a first fluid inlet cooperating with the quenching chamber, a second fluid inlet cooperating with the boiler and a third fluid inlet cooperating with a water line.

16. The cooking device according to claim 14, wherein the quenching chamber can be filled through at least one of a fourth fluid inlet cooperating with the inner casing, a fifth fluid inlet cooperating with the boiler and a sixth fluid inlet cooperating with a water line.

17. The cooking device according to claims 14, wherein the boiler can be filled through at least one of a seventh fluid inlet cooperating with the inner casing, an eighth fluid inlet cooperating with the quenching chamber and a ninth fluid inlet cooperating with a water line.

18. The cooking device according to claim 15, wherein at least one of the first fluid inlet is cooperating with at least one of a first shut-off device and/or pumping device, the second fluid inlet is cooperating with a second shut-off device and/or pumping device, the third fluid inlet is cooperating with a third shut-off device and/or pumping device, the fourth fluid inlet is cooperating with a fourth shut-off device and/or pumping device, the fifth fluid inlet is cooperating with a fifth shut-off device and/or pumping device, the sixth fluid inlet is cooperating with a sixth shut-off device and/or pumping device, the seventh fluid inlet is cooperating with a seventh shut-off device and/or pumping device, the eighth fluid inlet is cooperating with an eighth shut-off device and/or pumping device, and the ninth fluid inlet is cooperating with a ninth shut-off device and/or pumping device.

19. The cooking device according to claim 14, wherein the inner casing can be emptied through at least one of a first fluid outlet cooperating with the quenching chamber, a second fluid outlet cooperating with the boiler and a third fluid outlet cooperating with a water discharge.

20. The cooking device according to claim 14, wherein the quenching chamber can be emptied through at least one of a fourth fluid outlet cooperating with the inner casing, a fifth fluid outlet cooperating with the boiler and a sixth fluid outlet cooperating with a water discharge.

21. The cooking device according to claim 14, wherein the boiler can be emptied through at least one of a seventh fluid outlet cooperating with the inner casing, an eighth fluid outlet cooperating with the quenching chamber and a ninth fluid outlet cooperating with a water discharge.

22. The cooking device according to claim 19, wherein at least one of the first fluid outlet is cooperating with a tenth shut-off device and/or pumping device, the second fluid outlet is cooperating with an eleventh shut-off device and/or pumping device, the third fluid outlet is cooperating with a twelfth shut-off device and/or pumping device, the fourth fluid outlet is cooperating with a thirteenth shut-off device and/or pumping device, the fifth fluid outlet is cooperating with a fourteenth shut-off device and/or pumping device, the sixth fluid outlet is cooperating with a fifteenth shut-off device and/or pumping device, the seventh fluid outlet is cooperating with a sixteenth shut-off device and/or pumping device, the eighth fluid outlet is cooperating with a seventeenth shut-off device and/or pumping device, and the ninth fluid outlet is cooperating with an eighteenth shut-off device and/or pumping device.

23. The cooking device according to claim 18, wherein at least one of the first, second, third, fourth, fifth, sixth, seventh, eighth, ninth, tenth, eleventh, twelfth, thirteenth, fourteenth, fifteenth, sixteenth, seventeenth and eighteenth shut-off device and/or pumping device include least one valve.

24. The cooking device according to claim 18, wherein at least one of the first, second, third, fourth, fifth, sixth, seventh, eighth, ninth, tenth, eleventh, twelfth, thirteenth, fourteenth, fifteenth, sixteenth, seventeenth and eighteenth shut-off device and/or pumping device can be actuated through the control- or regulation device, especially always as a function of a comparison of the actual value of the characteristic parameter with at least one target value for the characteristic parameter.

25. The cooking device according to claim 24, wherein the pulse ratio of at least one of the first, second, third, fourth, fifth, sixth, seventh, eighth, ninth, tenth, eleventh, twelfth, thirteenth, fourteenth, fifteenth, sixteenth, seventeenth and eighteenth shut-off device and/or pumping device can be adjusted, especially controlled or regulated through the control- or regulation device.

26. The cooking device according to claim 8, wherein the filling- and/or charge-amount-monitoring device includes the ventilation device.

27. The method according to claim 3, wherein circulating at least a part of the fluid includes pulsing the pumping device.

28. The method according to claim 4, further comprising:
compensating for the reduction of the rotation speed by at least partly increasing power consumption by the motor and wherein detecting an increase of the rotation speed includes detecting an increase especially due to said compensation.

29. The method according to claim 5, wherein determining at least one of an upper limiting value of the rotation speed and a lower limiting value of the rotation speed is performed as a function of at least one of a pulsing of the pumping device, an amount of fluid introduced into the inner casing, an amount of fluid removed from the inner casing, a dimension of the cooking device, accessories in the cooking device and of a loading of the inner casing with cooking product.

30. The method according to claim 6, wherein determining a time difference from the time span between when the value goes below the lower limiting value and when the value goes above the upper limiting value is performed as a function of at least one of a pulsing of the pumping device, and a purpose of filling- and/or charge-amount-monitoring.

31. The method according to claim 7, wherein adjusting at least one of a device for the introduction of fluid to the inner casing and for removing fluid from the inner casing includes one of controlling and regulating the device.

32. The cooking device according to claim 9, wherein the motor is an electrically commutated motor.

33. The cooking device according to claim 10, wherein the pumping device cooperates with the control- or regulation device to adjust at least one of a pump output and a pulsing of the pumping device.

34. The cooking device according to claim 12, wherein the pulsing of the pumping device is taken into consideration by evaluating a time span between a first reduction of the rotation speed after turning on the pumping device and a first increase of the rotation speed after turning off the pumping device.

35. The cooking device according to claim 26, wherein the control- or regulation device at least partly, whereby the filling and/or charge-amount-monitoring device, also includes at least one of the first, second, third, fourth, fifth, sixth, seventh, eighth, ninth, tenth, eleventh, twelfth, thirteenth, fourteenth, fifteenth, sixteenth, seventeenth and eighteenth shut-off device and/or pumping device.
